(19) United States
(12) Patent Application Publication
(10) Pub. No.: US 2003/0226548 A1
(43) Pub. Date: Dec. 11, 2003

(54) Fuel feed unit for a motor vehicle

(75) Inventors: Bernd Herzog, Huenfeldan (DE); Helmut Nather, Bad Camberg (DE)

Correspondence Address: MORRISON & FOERSTER LLP, 1650 TYSONS BOULEVARD, SUITE 300, MCLEAN, VA, 22102, US

(73) Assignee: Siemens AG, Munich (DE)

(21) Appl. No.: 10/408,666

(22) Filed: Apr. 8, 2003

(30) Foreign Application Priority Data
Apr. 9, 2002 (DE) 102 15 652.2

(51) Int. Cl. F02M 1/00; F04F 5/44

(52) U.S. Cl. 123/514; 417/198

(57) ABSTRACT

A fuel feed unit for a motor vehicle, having a pressure-limiting valve arranged in a working fluid line of a suction jet pump which is arranged within a surge chamber of a fuel tank. Excess fuel therefore passes directly into the surge chamber via an outlet of the pressure-limiting valve. Unnecessary circulating of the fuel in the fuel tank is therefore avoided.

### TECHNICAL FIELD OF THE INVENTION

The invention relates to a fuel feed unit for a motor vehicle, and in particular, to a fuel feed unit having a surge chamber which is provided for arrangement in a fuel tank, and having a suction jet pump for guiding fuel from one region of the fuel tank into another region, in which a working fluid line of the suction jet pump has a pressure-limiting valve with an outlet.

### BACKGROUND OF THE INVENTION

Fuel feed units are frequently used in motor vehicles and are known in practice. The working fluid line is often connected to a return line guided back into the fuel tank from an internal combustion engine of the motor vehicle, or to a branch of a supply line and is arranged, for example, in a flange of the fuel tank. The pressure-limiting valve opens above a designated pressure and removes excess fuel via the outlet. This limits the maximum pressure in the working fluid line of the suction jet pump.

A disadvantage of the known fuel feed unit is that the fuel removed through the outlet of the pressure-limiting valve is circulated in the fuel tank in an uncontrolled manner. This leads to severe permeation of fuel into the surroundings and to disturbing noises.

### SUMMARY OF THE INVENTION

The invention discloses the design of a fuel feed unit in such a manner that it keeps the circulation of fuel in the fuel tank particularly small. This is achieved according to one embodiment of the invention by the outlet of the pressure-limiting valve leading into the surge chamber.

This design causes the fuel which has been removed by the pressure-limiting valve to pass into the suction region of the fuel feed unit according to the invention. The distances covered by the fuel which is removed via the outlet are thus kept particularly small. Furthermore, the fuel removed via the outlet flows in the surge chamber, with the result that circulation of the fuel outside the surge chamber in the fuel tank is avoided. A further advantage of this design is that flow noises at the pressure-limiting valve are damped by the surge chamber.

The pressure-limiting valve could be connected to the surge chamber via a line, for example. However, the fuel feed unit according to the invention requires particularly few components to be fitted if the pressure-limiting valve is arranged within the surge chamber. With an appropriate arrangement of the outlet, this causes the fuel which has been removed to pass automatically into the surge chamber.

According to another embodiment of the invention, the pressure-limiting valve turns out to be particularly simple in terms of structure if a connecting branch of the working fluid line or the distributor is manufactured integrally with part of a housing of the pressure-limiting valve.

According to still another embodiment of the invention, the components of the pressure-limiting valve can be fitted in a particularly simple manner if the connecting branch or the distributor of the working fluid line has a receptacle for components of the pressure-limiting valve.

According to yet another embodiment of the invention, the receptacle for the components of the pressure-limiting valve can be designed to be particularly small and compact if a cover of the pressure-limiting valve fits over the receptacle.

In one aspect of the invention, a plurality of suction jet pumps are frequently used, for example in the case of fuel tanks designed as a saddle tank, in order to feed the fuel from one chamber to another chamber. The fuel feed unit according to the invention provided for fuel tanks of this type requires a particularly low outlay if the pressure-limiting valve is arranged in a distributor for a plurality of suction jet pumps.

The fuel feed unit according to the invention can be produced particularly cost-effectively if the suction jet pump, the connecting branch of the working fluid line, a sub-region of the housing of the pressure-limiting valve and a flange for the connection of a fuel pump have a common basic body manufactured integrally.

A contribution is made to further reducing the number of components of the fuel feed unit according to the invention if the pressure-limiting valve is arranged between a housing of a distributor or the suction jet pump and a connecting branch.

### BRIEF DESCRIPTION OF THE DRAWINGS

The invention permits numerous embodiments. Additional embodiments of the invention are described below with reference to the drawings, in which:

FIG. 1 shows a fuel feed unit according to the invention arranged in a fuel tank.

FIG. 2 shows a basic body having a suction jet pump of the fuel feed unit according to the invention from FIG. 1 in an enlarged longitudinal section.

FIG. 3 shows a distributor of the fuel feed unit according to the invention from FIG. 1.

FIG. 4 shows a sectional illustration through the distributor from FIG. 3 along the line IV-IV.

### DETAILED DESCRIPTION OF THE INVENTION

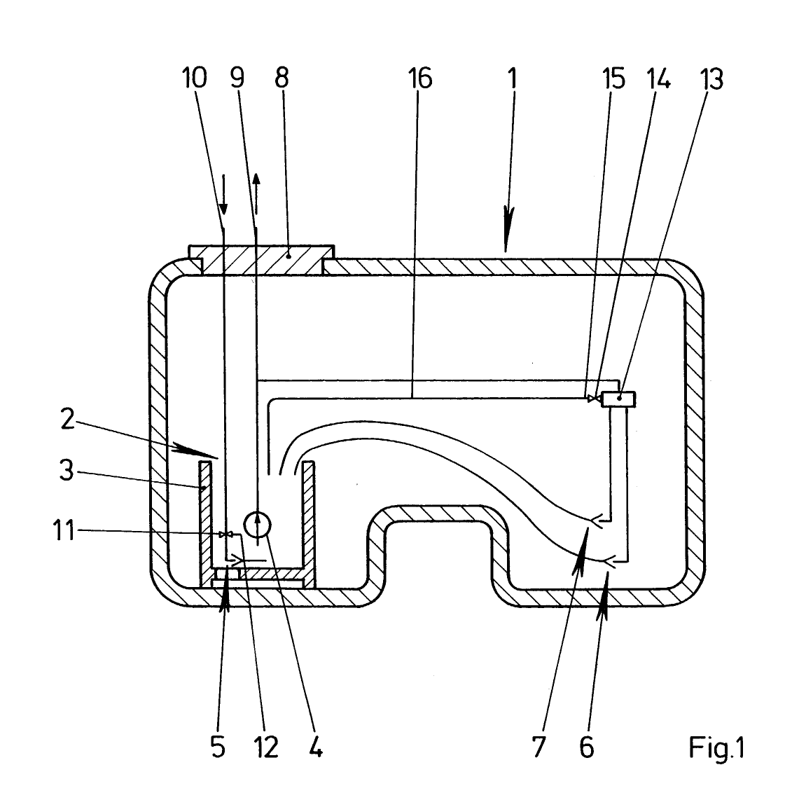

FIG. 1 shows a fuel tank 1 for a motor vehicle having a fuel feed unit 2 arranged therein, in a sectional illustration. The fuel feed unit 2 has a surge chamber 3 with a fuel pump 4 arranged in it and a plurality of suction jet pumps 5-7 for filling the surge chamber 3. The surge chamber 3 is arranged below an installation flange 8 of the fuel tank 1. The fuel pump 4 feeds fuel via a supply line 9 to an internal combustion engine (not illustrated) of the motor vehicle. Excess fuel is carried back into the fuel tank 1 via a return line 10. One of the suction jet pumps 5 is arranged in the surge chamber 3 and is connected to the return line 10 via a pressure-limiting valve 11. The return line 10 is therefore designed as a working fluid line for supplying the suction jet pump with working fluid. This suction jet pump 5 sucks up fuel from the bottom region of the fuel tank 1 and feeds it into the surge chamber 3. An outlet 12 of the pressure-limiting valve 11 leads directly into the surge chamber 3. The two further suction jet pumps 6, 7 are arranged in a region of the fuel tank 1 remote from the surge chamber 3 and are connected to the supply line 9 via a distributor 13. These suction jet pumps 6, 7 feed fuel into the surge chamber 3 from that region of the fuel tank 1 which is remote from the surge chamber 3. A pressure-limiting valve 14 is arranged in the distributor 13 and has an outlet 15 to which a line 16, which is guided into the surge chamber 3, is connected.

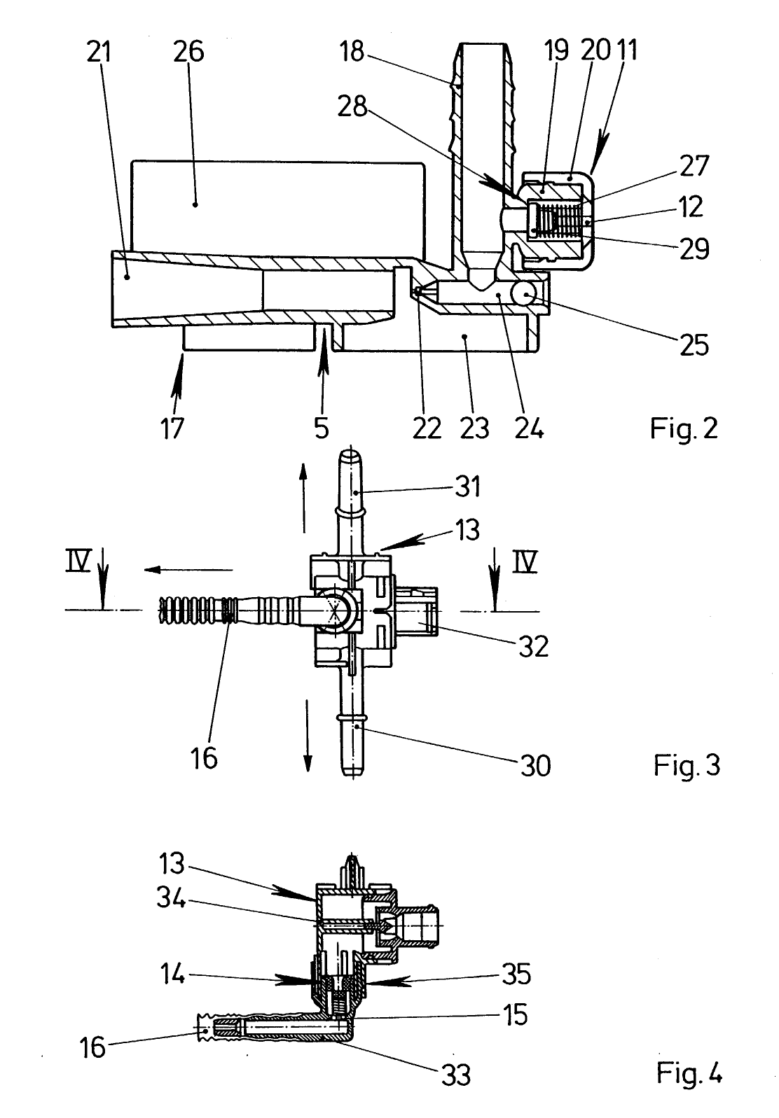

FIG. 2 shows a basic body 17 having the suction jet pump 5, which is arranged in the bottom region of the surge chamber 3 from FIG. 1, and having the pressure-limiting valve 11. The pressure-limiting valve 11 is arranged in a connecting branch 18 for the return line 10. The connecting branch 18 is manufactured integrally with a receptacle 19 in order to accommodate the components of the pressure-limiting valve 11. The receptacle 19 has a cover 20 fitted over it. The suction jet pump 5 has a mixing pipe 21 and a nozzle 22. Located between the nozzle 22 and the mixing pipe 21 is a suction region 23 of the suction jet pump 5 which penetrates the bottom of the surge chamber 3, which is illustrated in FIG. 1. In order to simplify the manufacturing of the basic body 17, a channel 24, which is guided to the nozzle 22 of the suction jet pump 5, is closed by a pressed-in ball 25. Furthermore, the basic body 17 has a flange 26 for the connection of the fuel pump 4, which is illustrated in FIG. 1. The pressure-limiting valve 11 has a valve body 29 which is pre-stressed against a valve seat 28 by a spring 27. When a designated pressure in the connecting branch 18 of the return line 9 is exceeded, the valve body 29 is pressed away from the valve seat 28 and excess fuel can emerge through the outlet 12 into the surge chamber 3, which is illustrated in FIG. 1.

FIG. 3 shows the distributor 13 from FIG. 1 with two outlets 30, 31 for the suction jet pumps 6, 7, which are illustrated in FIG. 1, and a connection 32 for the supply line 9. FIG. 4 shows, in a sectional illustration through the distributor 13 from FIG. 3 along the line IV-IV, that the pressure-limiting valve 14 is arranged between a connecting branch 33 of the outlet 15 and a housing 34 of the distributor 13. The connecting branch 33 of the outlet 15 and the housing 34 of the distributor 13 are connected to each other via a latching connection 35. The pressure-limiting valve 14 is constructed in the same manner as the pressure-limiting valve 11, which is illustrated in FIG. 2.

What is claimed is:

1. A fuel feed unit for a motor vehicle, comprising:
a surge chamber provided for arrangement in a fuel tank, and having a suction jet pump for guiding fuel from one region of the fuel tank into another region, in which a working fluid line of the suction jet pump has a pressure-limiting valve with an outlet, wherein the outlet of the pressure-limiting valve leads into the surge chamber.

2. The fuel feed unit as claimed in claim 1, wherein the pressure-limiting valve is arranged within the surge chamber.

3. The fuel feed unit as claimed in claim 1, wherein the pressure-limiting valve is arranged in a distributor for a plurality of suction jet pumps.

4. The fuel feed unit as claimed in claim 1, further comprising a connecting branch of the working fluid line or the distributor is manufactured integrally with part of a housing of the pressure-limiting valve.

5. The fuel feed unit as claimed in claim 4, wherein the connecting branch or the distributor of the working fluid line has a receptacle for components of the pressure-limiting valve.

6. The fuel feed unit as claimed in claim 5, wherein a cover of the pressure-limiting valve fits over the receptacle.

7. The fuel feed unit as claimed in claim 1, wherein the suction jet pump, the connecting branch of the working fluid line, a sub-region of the housing of the pressure-limiting valve and a flange for the connection of a fuel pump have a common basic body manufactured integrally.

8. The fuel feed unit as claimed in claim 1, wherein the pressure-limiting valve is arranged between a housing of the distributor or the suction jet pump and a connecting branch.
